(19) United States
(12) Patent Application Publication
(10) Pub. No.: US 2019/0143759 A1
(43) Pub. Date: May 16, 2019

(54) PNEUMATIC TIRE AND TIRE CURE METAL MOLD

(71) Applicant: TOYO TIRE & RUBBER CO., LTD., Itami-shi (JP)

(72) Inventor: Sachio Sakamoto, Itami-shi (JP)

(73) Assignee: TOYO TIRE & RUBBER CO., LTD., Itami-shi (JP)

(21) Appl. No.: 16/168,007

(22) Filed: Oct. 23, 2018

(30) Foreign Application Priority Data
Nov. 10, 2017 (JP) 2017-217524

(51) Int. Cl. B60C 13/00; B60C 13/02; B60C 15/06; B60C 15/024

(52) U.S. Cl. CPC B60C 13/001; B60C 13/02; B60C 9/02; B60C 15/024; B60C 15/0628

(57) ABSTRACT

A pneumatic tire has a pair of bead portions, a pair of side wall portions which extend from the bead portions to an outer side in a tire diametrical direction, a tread portion which is connected to an outer side end of each of the pair of side wall portions in the tire diametrical direction, a plurality of projections which are provided in a buttress region of the side wall portions along a tire circumferential direction; and a plurality of spews which protrude out of surfaces of the projections. In each of a plurality of sides forming a periphery of the surfaces of the projections, in the case that rectangular areas having a distance from the side being in a range of 2.5 mm or less are defined on the surfaces of the projections, at least one spew is provided in each of the rectangular areas.

### BACKGROUND OF THE INVENTION

### Field of the Invention

The present invention relates to a pneumatic tire which is provided with a plurality of projections in a buttress region of a side wall portion, and a tire cure metal mold for cure molding the pneumatic tire.

### Description of the Related Art

There has been known a pneumatic tire which is provided with a plurality of projections in a buttress region of a side wall portion along a tire circumferential direction. The tire mentioned above is disclosed, for example, in Patent Document 1 filed by the applicant of the present application. In a situation of traveling on a punishing road such as a muddy ground and a sand pool or an ice and snow road, it is possible to improve a traveling performance by generating traction on the basis of a shear resistance of the projections.

Further, the projections provided in the buttress region affect not only a functional aspect of the tire as mentioned above, but also a design aspect of the tire. For example, it is possible to enhance a design property of a tire side surface by increasing a stereoscopic effect of the buttress region by the projections. However, in the case that the projections are protruded so greatly that the stereoscopic effect is generated, a molding defect called as bare tends to be generated due to a rubber fracture. This is because the rubber is hard to be filled in a concave portion of a metal mold for molding the projections according to an enlargement of the protruding amount of the projections.

On the contrary, there can be thought that a vent hole is set in the concave portion for molding the projections, thereby suppressing the molding defect of the projections. According to the method mentioned above, it is possible to enhance a flow property of the rubber by reducing a residual air within the concave portion when cure molding time, and it is possible to promote the filling of the rubber to the concave portion. However, on the other hand, a spew (which may be called also as a vent spew) is formed by the rubber entering into the vent hole. As a result, there comes a state in which a plurality of spews disorderly protrude out of the surfaces of the projections after the cure molding, and the design property is in risk of being deteriorated.

Patent Document 2 describes a pneumatic tire which is provided with a plurality of projections in a side wall portion along a tire circumferential direction. However, this is not a technique relating to the projections in the buttress region which may generate the traction on the punishing road or the ice and snow road, but is a technique relating to the projections which are provided around a tire maximum width positon for improving a cooling efficiency of the side wall portion. Accordingly, this technique does not suggest any solving means for the problem mentioned above relating to the design property in the tire side surface.

### PRIOR ART DOCUMENT

### Patent Document

Patent Document 1: JP-A-2013-82262

Patent Document 2: JP-A-2013-71669

### SUMMARY OF THE INVENTION

### Problem to be Solved by the Invention

The present invention is made by taking the actual condition mentioned above into consideration, and an object of the present invention is to provide a pneumatic tire which can reduce deterioration of a design property in a tire side surface due to the spew while suppressing the molding defect of the projections in the buttress region, and a tire cure metal mold which is used for cure molding the pneumatic tire.

### Means for Solving the Problem

The object can be achieved by the following present invention. The present invention provides a pneumatic tire comprising a pair of bead portions, a pair of side wall portions which extend from the bead portions to an outer side in a tire diametrical direction, a tread portion which is connected to an outer side end of each of the pair of side wall portions in the tire diametrical direction, a plurality of projections which are provided in a buttress region of the side wall portions along a tire circumferential direction, and a plurality of spews which protrude out of surfaces of the projections, wherein in each of a plurality of sides forming a periphery of the surfaces of the projections, in the case that rectangular areas having a distance from the side being in a range of 2.5 mm or less are defined on the surfaces of the projections, at least one spew is provided in each of the rectangular areas.

The pneumatic tire is structured such that the spews protrude out of the surfaces of the projections in the buttress region, and a metal mold provided with vent holes on a bottom surface of a concave portion for forming the projections is used for cure molding the same. As a result, it is possible to suppress the molding defect of the projections in the buttress region. Further, a group of spews are famed along a surface shape of the projections by a plurality of spews which are provided in the rectangular area as mentioned above, and a periphery of the surfaces of the projections is fo fled into a decorated outer appearance by the group of spews. Therefore, it is possible to reduce the deterioration of the design property in the tire side surface due to the spews.

It is preferable that a distance between a center of the spew provided in the rectangular area and the side closest to the spew is 1.3 mm or more. According to the structure mentioned above, since the group of spews along the surface shape of the projections are appropriately and approximately evenly away from the periphery of the surfaces of the projections, a decoration effect can be enhanced.

It is preferable that a protruding amount of the spew positioned closest to an outer side in the tire diametrical direction on the surfaces of the projections is greater than a protruding amount of the spew positioned closest to an inner side in the tire diametrical direction. It is possible to increase the stereoscopic effect of the projections in the buttress region and enhance the design property by differentiating the protruding amounts of the spews as mentioned above.

Since a metal mold provided with a groove-shaped saw cut on a bottom surface of a concave portion for forming the projections is used as long as a linear ridge is provided on the surfaces of the projections, it is possible to effectively suppress the molding defect of the projections. In the case mentioned above, the ridge extending along the side preferably connects the spews each other. Since the metal mold in which the vent holes are connected by the saw cut on the bottom surface of the concave portion for forming the projections is used for cure molding the tire, it is possible to more effectively suppress the molding defect of the projection.

The present invention provides a tire cure metal mold comprising a tire forming surface which comes into contact with an outer surface of a tire set in a cavity, a plurality of concave portions which are provided in a buttress region contact portion of the tire forming surface along a tire circumferential direction, and a plurality of vent holes which are provided on bottom surfaces of the concave portions, wherein in each of a plurality of sides forming a periphery of the bottom surfaces of the concave portions, in the case that rectangular areas having a distance from the side being in a range of 2.5 mm or less are defined on the bottom surfaces of the concave portions, at least one vent hole is provided in each of the rectangular areas.

In the tire cure metal mold, the vent holes are provided on the bottom surface of the concave portion of the buttress region contact portion. As a result, it is possible to promote the filling of the rubber to the concave portion by reducing the residual air within the concave portion when cure molding time, thereby suppressing the molding defect of the projections in the buttress region. Further, in the tire in which the group of spews are formed along the surface shape of the projection by a plurality of spews formed by the vent holes provided in the rectangular area as mentioned above and cure molded, since periphery of the surfaces of the projections is formed into the decorated outer appearance by the group of spews, it is possible to reduce the deterioration of the design property in the tire side surface due to the spews.

It is preferable that a distance between a center of the vent hole provided in the rectangular area and the side closest to the vent hole is 1.3 mm or more. According to the structure mentioned above, since the group of spews along the surface shape of the projections are appropriately and approximately evenly away from the periphery of the surfaces of the projections in the cure molded tire, the decoration effect can be enhanced.

According to the structure in which the groove-shaped saw cut is provided on the bottom surface of the concave portion, it is possible to effectively suppress the molding defect of the projections by efficiently reducing the residual air within the concave portion at the cure molding time. In the case mentioned above, the saw cut extending along the side preferably connects the vent holes to each other. According to the structure mentioned above, it is possible to more effectively suppress the molding defect of the projections by further efficiently reducing the residual air within the concave portion at the cure molding time.

### BRIEF DESCRIPTION OF THE DRAWINGS

FIG. 1 is a half cross sectional view along a tire meridian and schematically shows an example of a pneumatic tire according to the present invention;

FIG. 2 is an expansion plan view of an outer surface of the pneumatic tire;

FIG. 3 is a view showing one of projections in a buttress region;

FIG. 4 is an enlarged view showing one of sides which form a periphery of surfaces of the projections;

FIG. 5 is a cross sectional view schematically showing a modified example in which a protruding amount of the spews is changed;

FIG. 6 is a cross sectional view schematically showing a modified example in which a protruding amount of the spews is changed little by little;

FIG. 7 is a schematic view showing a modified example in which a diameter of the spews is changed;

FIG. 8 is a schematic view showing a modified example in which a diameter of the spews is changed little by little;

FIG. 9 is a schematic view showing a modified example in which a diameter of the spews is changed;

FIG. 10 is a schematic view showing a modified example in which ridges are provided in surfaces of the projections;

FIG. 11 is a vertical cross sectional view schematically showing an example of a tire cure metal mold according to the present invention;

FIG. 12 is a view showing one of concave portions in a buttress region contact portion; and

FIG. 13 is a view schematically showing a modified example in which a saw cut is provided on a bottom surface of the concave portions.

### DETAILED DESCRIPTION OF THE PREFERRED EMBODIMENTS

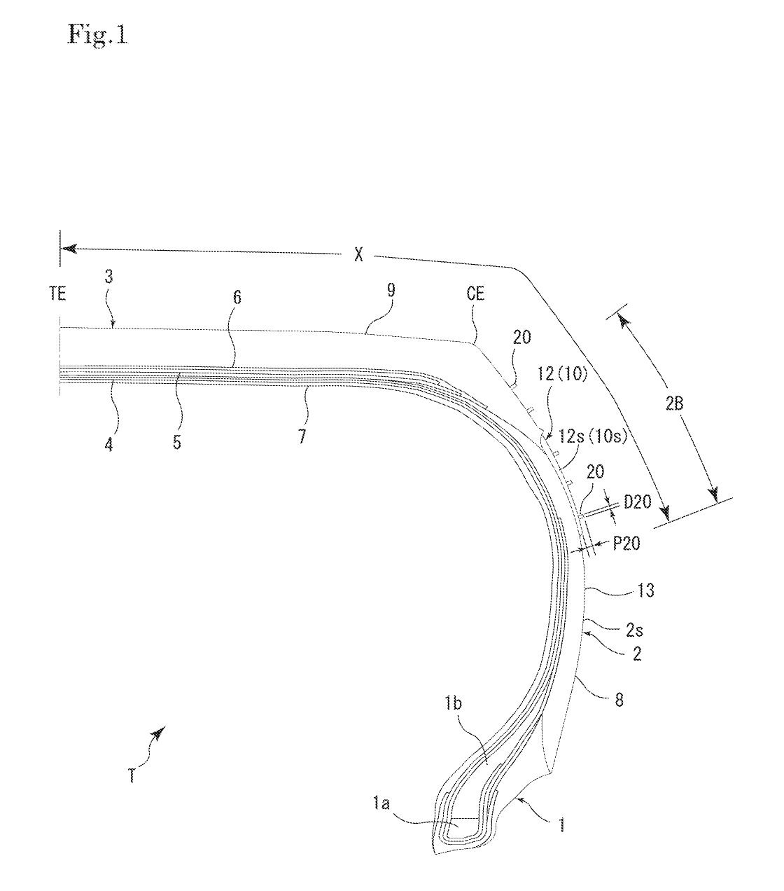

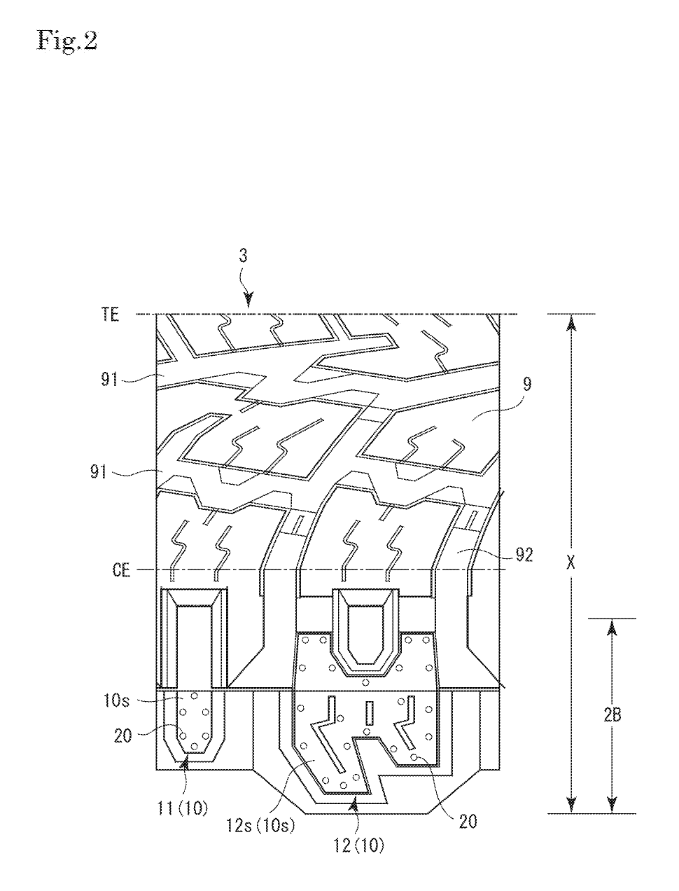

An embodiment of the present invention will be explained with reference to the drawings. FIG. 1 is a half cross sectional view along a tire meridian and schematically shows an example of a pneumatic tire according to the present invention. FIG. 2 is an expansion plan view of an outer surface of the pneumatic tire. FIG. 2 shows a range X including a range from a tire equator TE to a buttress region 2B.

In the present embodiment, there is shown an example in which a pneumatic tire T is an off-road pneumatic radial tire aiming at traveling on a punishing road including muddy ground and rocky stretch. The pneumatic tire T is provided with a pair of bead portions 1, a pair of side wall portions 2 which extend to an outer side in a tire diametrical direction from the bead portions 1, and a tread portion 3 which is connected to an outer side end in the tire diametrical direction of each of a pair of side wall portions 2. In the bead portion 1, there are buried an annular bead core 1a which is famed by coating with rubber a convergence body such as a steel wire, and a bead filler 1b which is arranged in an outer side of the bead core 1a in the tire diametrical direction.

A carcass 4 is provided between a pair of bead portions 1. The carcass 4 is famed into a toroidal shape as a whole, and is wound up in such a manner that an end portion thereof pinches the bead core 1a and the bead filler 1b. A belt 5 is provided in an outer side of the carcass 4 in the tire diametrical direction in the tread portion 3. The belt 5 is constructed by two belt plies which are laminated inward and outward. A belt reinforcing member 6 is provided in an outer side of the belt 5 in the tire diametrical direction. An inner surface of the tire T is formed by an inner liner 7 which is excellent in an airtight retention capacity.

A side wall rubber 8 is provided in an outer side of the wound-up portion of the carcass 4 in a tire width direction. An outer surface of the side wall portion 2 is formed mainly by the side wall rubber 8. A tread rubber 9 is provided in an outer side of the belt reinforcing member 6 in the tire diametrical direction. An outer surface of the tread portion 3 is famed by the tread rubber 9. Although an illustration is omitted in FIG. 1, a groove portion including a main groove 91 and a lateral groove 92 is provided on a surface of the tread rubber 9, and a tread pattern is formed thereby. The tread pattern of the tire T is not particularly limited.

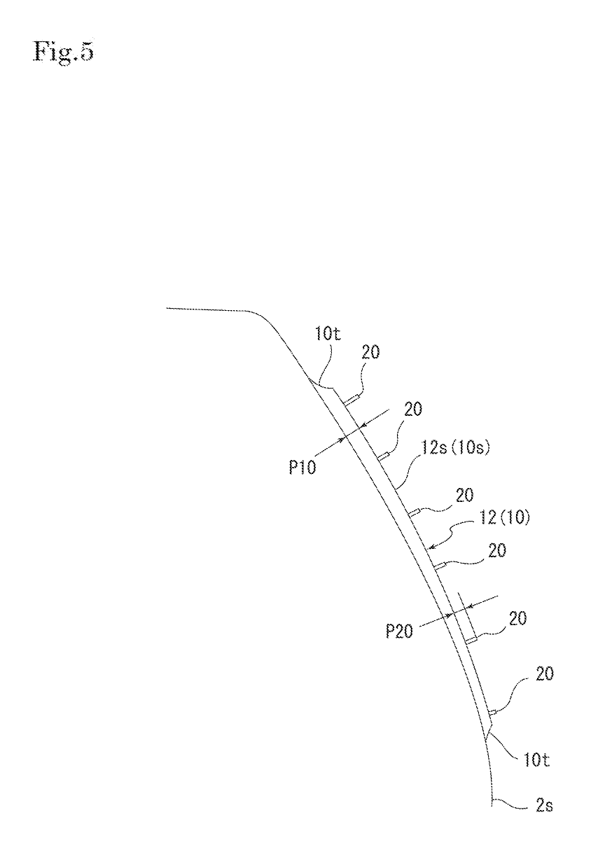

The pneumatic tire T is provided with a plurality of projections 10 which are provided in a buttress region 2B of the side wall portion 2 along a tire circumferential direction, and a plurality of spews 20 which protrude out of a surface 10s of the projection 10. The projection 10 is upraised from a surface 2s of the side wall portion 2 along a profile line of the tire T. The projection 10 has the surface 10s which is directed to an outer side in the tire width direction, and a side surface 10t which rises up from the surface 2s and gets to the surface 10s (refer to FIG. 5). The projection 10 is arranged between a ground end CE and a tire maximum width position 13. In a situation of traveling on a punishing road such as muddy ground and sand pool, or an ice and snow road, it is possible to improve a traveling performance by generating traction on the basis of a shear resistance of the projection 10.

The buttress region 2B is a region in an outer side of the side wall portion 2 in the tire diametrical direction, more specifically, a region closer to the outer side in the tire diametrical direction than a tire maximum width position 13, and is a portion which does not ground when normally traveling on a flat paved road. Since the tire sinks due to weight of the vehicle on a soft road such as the muddy ground, the sand pool, and the ice and snow road, the buttress region 2B grounds in a pseudo manner. The tire maximum width position 13 is a position where the profile line of the tire T is most apart from the tire equator TE in the tire width direction. The profile line is a contour line which forms an outer surface of the side wall portion 2 except a projecting object such as a rim protector, and generally has a meridian cross sectional shape which is defined by smoothly connecting a plurality of circular arcs.

The tread pattern shown in FIG. 2 is repeated along the tire circumferential direction, thereby a group of projections which is annular. The group of projections is constructed by a lot of projections 10 which are arranged at distances each other. In the present embodiment, the projection 10 in the buttress region 2B includes two kinds of projections 11 and 12, however, may include one kind or three kinds of more projections . In an expansion plan view shown in FIG. 2, each of the projections 11 and 12 has a shape in which a length in the tire width direction (a vertical direction in FIG. 2) is greater than a length in the tire circumferential direction. Further, in this expansion plan view, the projections 11 and 12 are formed into a polygonal shape. More specifically, the projection 11 is formed into a hexagonal shape, and the projection 12 is formed into a heptadecagonal shape.

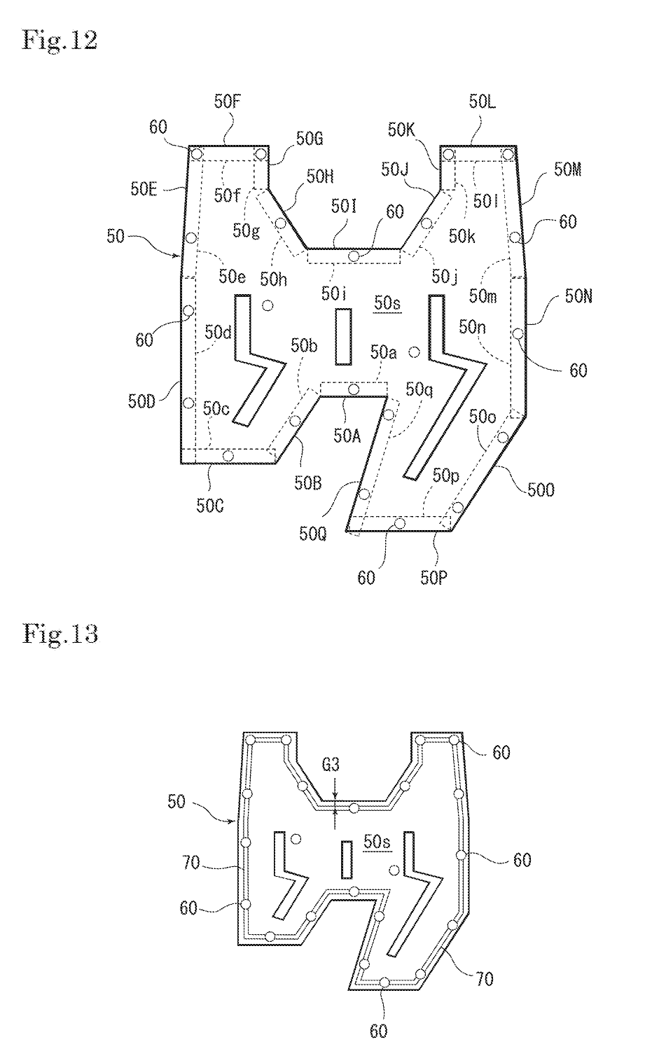

The spew 20 is a projecting object which is formed by a rubber entering into the vent hole 60 (refer to FIG. 12) at the cure molding time. A protruding amount P20 of the spew 20 is, for example, between 1.0 and 5.0 mm. The protruding amount P20 is measured on the basis of the surface 10s of the projection 10. A diameter D20 of the spew 20 is, for example, between 1.3 and 2.5 mm. The diameter D20 is measured on the surface 10s of the projection 10. The spew 20 exists as a stubbed cut mark obtained by cutting off a leading end portion, however, may be formed into a shape just after the molding in which the leading end portion is not cut off, without being limited to the above.

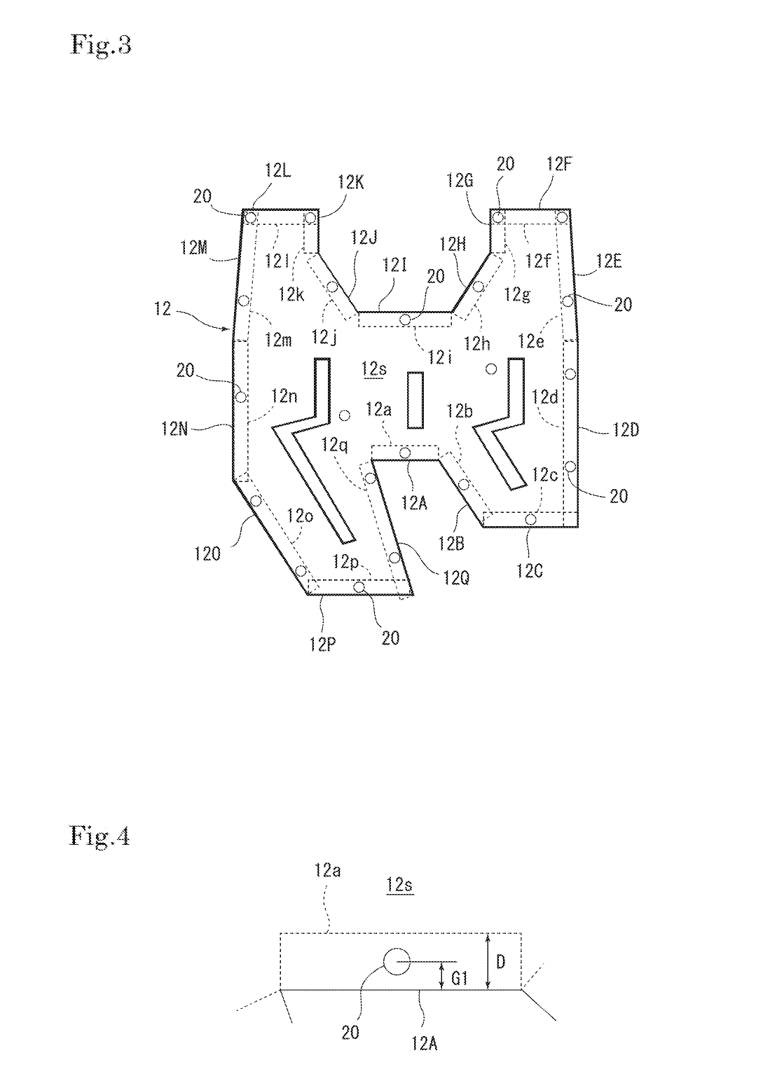

FIG. 3 shows the projection 12 by extracting the projection 12 from the expansion plan view in FIG. 2, and FIG. 4 shows a side 12A of the projection 12 in an enlarged manner. A periphery of the surface 12a of the projection 12 is formed by a plurality of (seventeen in the present embodiment) sides 12A to 12Q. The shortest side among a plurality of sides 12A to 12Q has a length, for example, 4.0 mm or more. The rectangular area 12a is an area in which a distance D from the side 12A is in a range of 2.5 mm or less, and is defined toward the surface 12s of the projection 12. The distance D is a distance in a vertical direction to the side 12A. In the same manner as the definition of the rectangular area 12a in relation to the side 12A, rectangular areas 12b to 12q are defined respectively in relation to the sides 12B to 12Q.

As shown in FIG. 3, in the tire T, in the case that the rectangular areas 12a to 12q having the distances from the sides 12A to 12Q in the range of 2.5 mm or less are defined on the surface of the projection 12, in relation to each of a plurality of sides 12A to 12Q forming the periphery of the surface 12s of the projection 12, at least one spew 20 is provided in each of the rectangular areas 12a to 12q. As a result, a group of spews are formed along the surface shape of the projection 12, and the periphery of the surface 12s of the projection 12 is formed into the decorated outer appearance by the group of spews. Therefore, it is possible to reduce the deterioration of the design property in the tire side surface due to the spews 20.

In the case that the spew 20 is provided at a position where a plurality of rectangular areas overlap, the spew 20 is assumed to be provided at each of the rectangular areas. For example, the spew 20 is provided at a position where the rectangular area 12f and the rectangular area 12g overlap, in FIG. 3. In this case, the spew 20 is assumed to be provided at each of the rectangular area 12f and the rectangular area 12g. In the present embodiment, the spew 20 is also provided at a center portion of the surface 12s. The spew may be formed in a place which is deviated from the rectangular areas 12a to 12q as mentioned above, however, they do not construct the group of spews along the surface shape of the projection 12.

The group of spews working well in the decoration effect as mentioned above is also formed in the projection 11. More specifically, in the case of forming a rectangular area in which a distance from each of a plurality of sides forming the periphery of the surface of the projection 11 is in a range of 2.5 mm or less on the surface of the projection 11, at least one spew 20 is provided in each of the rectangular areas. In the present description, the matter described the spew 20 of the projection 12 can be applied to the spew 20 which is formed in the projection 11.

In the spew 20 provided in the rectangular area, at least a part of the spew 20 may be provided within the rectangular area, however, the center of the spew 20 is preferably provided within the rectangular area. Further, a distance G1 (refer to FIG. 4) between the center of the spew 20 provided in the rectangular area and the side closest to the spew 20 is preferably 1.3 mm or more. As a result, since the group of spews along the surface shape of the projection 12 is appropriately and approximately evenly away from the periphery of the surface 12s of the projection 12, the decoration effect is enhanced. In each of the spews 20 constructing the group of spews along the surface shape of the projection 12, the decoration effect can be further enhanced in the case that the distance G1 is set to be uniform (for example, fixedly 1.5 mm).

In the projection 10 where the group of spews working well in the decoration effect as mentioned above are formed, the number of the sides forming the periphery of the surface 10s thereof is preferably six or more, and more preferably eight or more. The protruding amount P10 (refer to FIG. 5) of the projection 10 where the group of spews working well in the decoration effect are formed is preferably 5 mm or more and more preferably 8 mm or more. In the case that the protruding amount P10 varies along the tire diametrical direction, the maximum value thereof is preferably in the range mentioned above. In order to enhance the decoration effect on the basis of the group of spews, two or more spews 20 are preferably provided in the rectangular area which is defined in relation to the side in which the length goes beyond 4.0 mm.

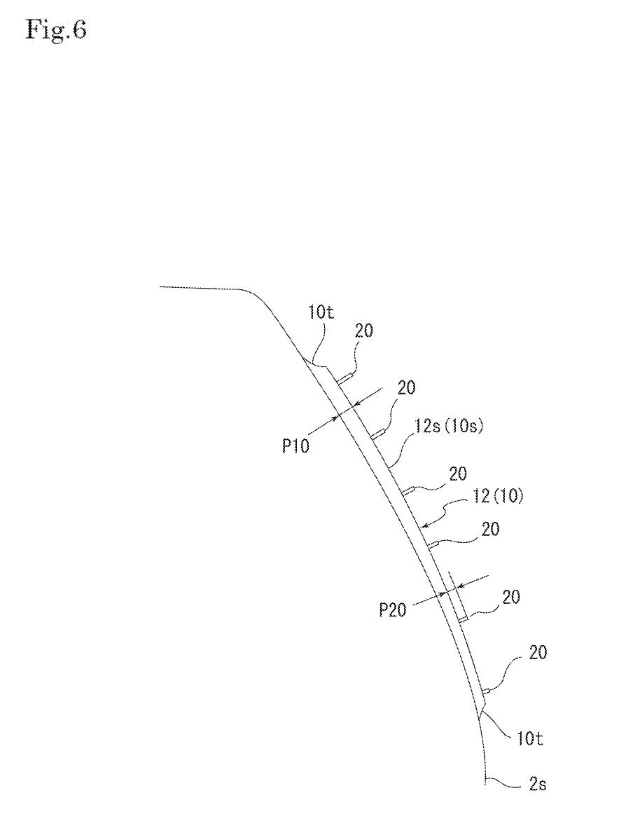

In the present embodiment, in the group of spews along the surface shape of the projection 12, the protruding amount P20 of the spew 20 is set to be uniform. However, the protruding amount P20 may be varied. For example, it can be thought to make the protruding amount P20 of the spew 20 positioned closest to the outer side in the tire diametrical direction on the surface 12s of the projection 12 greater than the protruding amount P20 of the spew 20 positioned closest to the inner side in the tire diametrical direction, as shown in FIG. 5. As a result, it is possible to increase the stereoscopic effect of the projection 10 and enhance the design property. In the case that the protruding amount P10 of the projection 10 is enlarged toward the outer side in the tire diametrical direction, a greater improving effect can be obtained. FIG. 6 shows an example in which the protruding amount P20 is enlarged little by little toward the outer side in the tire diametrical direction, and it is possible to increase the stereoscopic effect of the projection 10 in the same manner. The protruding amount P20 can be adjusted in a step of cutting off the leading end portion of the spew 20.

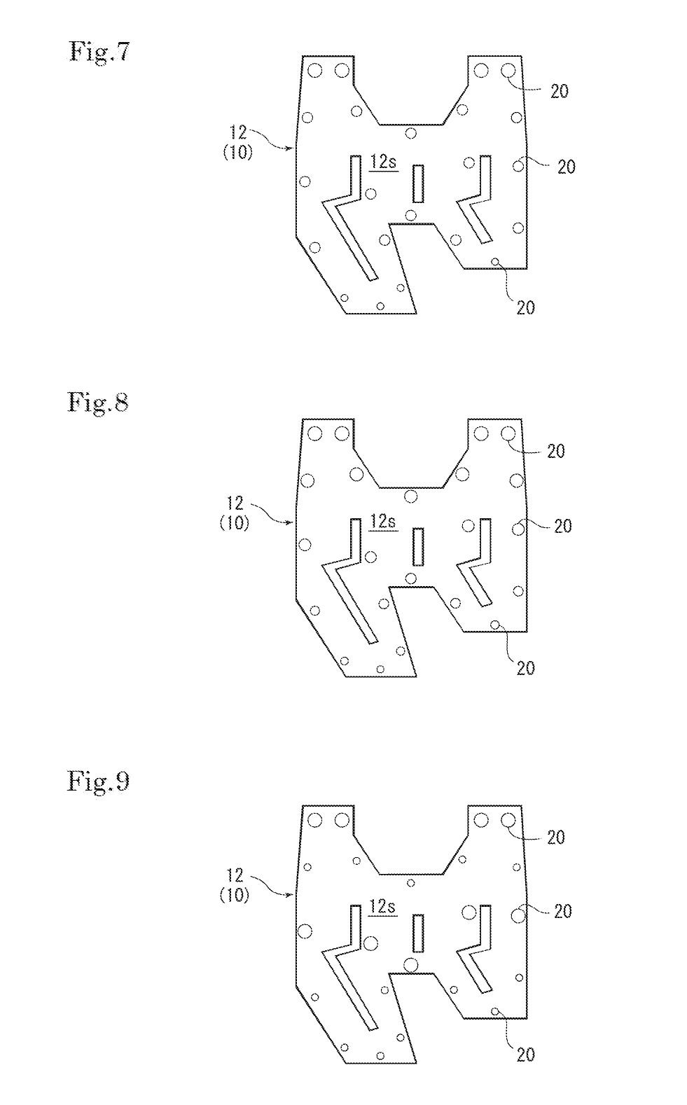

In the present embodiment, the diameter D20 of the spew 20 is set to be uniform in the group of spews along the surface shape of the projection 12. However, the diameter D20 may be varied. For example, it can be thought to make the diameter D20 of the spew 20 positioned closest to the outer side in the tire diametrical direction on the surface 12s of the projection 12 greater than the diameter D20 of the spew 20 positioned closest to the inner side in the tire diametrical direction, as shown in FIG. 7. Alternatively, it can be thought to enlarge the diameter D20 little by little toward the outer side in the tire diametrical direction as shown in FIG. 8. As a result, it is possible to increase the stereoscopic effect of the projection 10 and enhance the design property. In some shape of the projection 10, the spew 20 having the relatively larger diameter and the spew 20 having the relatively smaller diameter may be alternately arranged as shown in FIG. 9. These structure can be used by being combined with the structure in which the protruding amount P20 is varied as mentioned above.

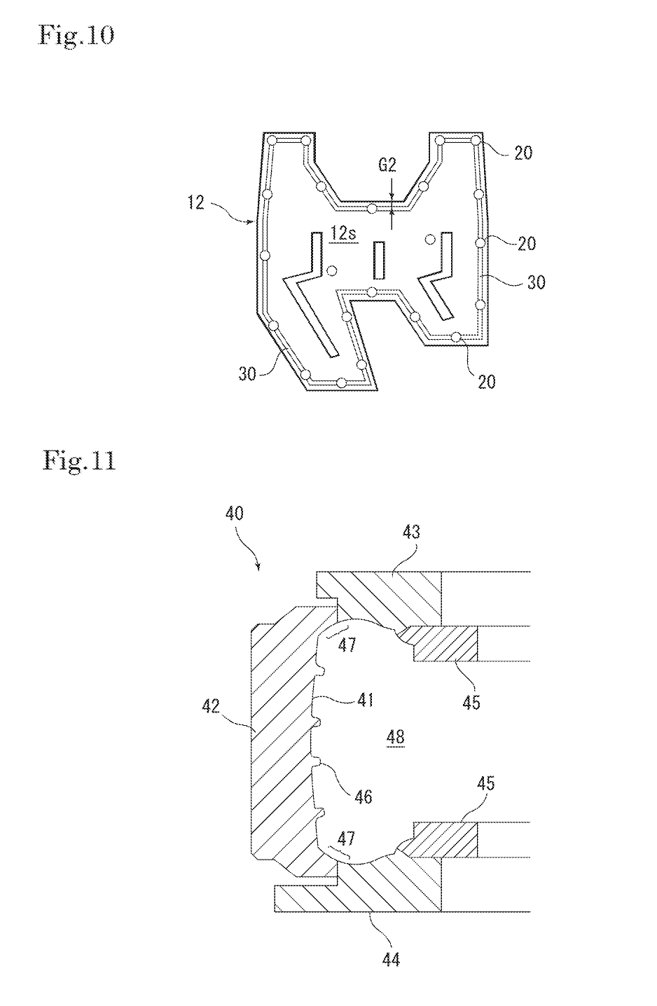

FIG. 10 shows an example in which linear ridges 30 are provided on the surface 12s of the projection 12. The ridge 30 is upraised from the surface 12s of the projection 12. The ridge 30 is famed by a groove-shaped saw cut 70 (refer to FIG. 13) which is provided on a bottom surface of a concave portion 50 for forming the projection mentioned later. Since a metal mold having the saw cut 70 is used, it is possible to effectively suppress the molding defect of the projection. A semicircular shape, a triangular shape, and a trapezoidal shape are exemplified as a cross sectional shape of the ridge 30. The ridge 30 is away from the sides (the sides 12A to 12Q) forming the periphery of the surface 12s of the projection 12, and a distance G2 thereof is preferably 1.3 mm or more.

In the example of FIG. 10, the ridge 30 extending along each of a plurality of sides forming the periphery of the surface 12s of the projection 12 connects the spews 20 each other. According to the structure mentioned above, the outer appearance is formed in such a manner that the periphery of the surface 12s of the projection 12 is decorated by the group of spews along the surface shape of the projection 12 and the ridges 30, and the decoration effect is enhanced. Further, since the vent holes 60 are connected each other by the saw cut 70, it is possible to efficiently reduce the residual air within the concave portion 50 at the cure molding time, and it is possible to more effectively suppress the molding defect of the projection 10.

The ridge 30 may not be connected to the spew 20. Therefore, both ends of the ridge 30 shown in FIG. 10 may be structured so as to be away from the spew 20. Further, in the example of FIG. 10, the ridge 30 extends along the side near the ridge 30, however, is not limited to this structure. For example, the ridge 30 maybe provided to extend so as to connect the spew 20 provided in the rectangular area 12e and the spew 20 provided in the rectangular area 12h. In the present embodiment, the ridge 30 extends in a linear shape or a V-shaped form, however, may extend, for example, in a curved shape or a zigzag shape without being limited to the above.

In the present embodiment, the arrangement of the spews 20 as mentioned above, that is, the formation of the group of spews along the surface shape of the projection 10 is employed in all the projections 10 which are provided in the buttress region 2B.

The structure of the buttress region 2B as mentioned above may be applied to at least the wall portion 2 in one side, however, is preferably applied to the side wall portions 2 in both sides.

The pneumatic tire according to the present invention can be structured in the same manner as the general pneumatic tire except the provision of the spews on the surface of the projection in the buttress region as mentioned above. Therefore, the conventionally known materials, shapes, structures, and manufacturing methods relating to the pneumatic tire can be all employed in the present invention.

Next, a description will be given of a tire cure metal mold for cure molding the pneumatic tire T. FIG. 11 shows a cross section of a tire cure metal mold 40 along a tire meridian cross section, and the tire cure metal mold 40 is in a mold clamping state. The tire is set in a state in which the tire width direction is oriented to up and down. In FIG. 11, a leftward direction indicates the outer side in the tire diametrical direction and a rightward direction indicates the inner side in the tire diametrical direction. The tire cure metal mold 40 is provided with a tire forming surface 41 which comes into contact with an outer surface of the tire set in a cavity 48.

The tire cure metal mold 40 according to the present embodiment is provided with a tread mold portion 42 which forms the tread portion of the tire, side mold portions 43 and 44 which form the side wall portion of the tire, and a pair of bead rings 45 to which the bead portions of tire are fitted. The tire forming surface 41 is mainly formed by an inner peripheral surface of the tread mold portion 42 and inner peripheral surfaces of the side mold portions 43 and 44. The tire forming surface 41 is provided with a bone portion 46 which protrudes out toward the inner side in the tire diametrical direction, and the groove portions such as the main groove 91 and the lateral groove 92 are formed thereby. The buttress region contact portion 47 is a portion which comes into contact with the buttress region 2B of the tire.

A shape of the portion coming into contact with the range X shown by FIG. 1 in the tire forming surface 41 corresponds to a reverse to the expansion plan view of FIG. 2. The metal mold 40 is provided with a plurality of concave portions which are provided in the buttress region contact portion 47 of the tire forming surface 41 along the tire circumferential direction, and a plurality of vent holes which are provided on bottom surfaces of the concave portions. FIG. 12 shows a concave portion 50 for forming the projection 12. The concave portion 50 has a bottom surface 50s heading for an outer side in the tire width direction. A plurality of vent holes 60 are provided on the bottom surface 50s. The vent hole 60 is a pierced hole which is famed in the tire forming surface 41, however, a tubular body called as a vent piece may be installed thereto.

In this metal mold 40, in each of a plurality of sides 50A to 50Q forming the periphery of the bottom surface 50s of the concave portion 50, at least one vent hole 60 is provided in each of the rectangular areas 50a to 50q in the case that the rectangular areas 50a to 50q having the distances from the sides 50A to 50Q being in the range of 2.5 mm or less are defined in the bottom surface 50s of the concave portion 50. The projection 12 is formed by the rubber which is filled in the concave portion 50, and the spew 20 is formed by the rubber which enters into the vent hole 60. Therefore, in the tire cure molded by using the metal mold 40, the group of spews are famed along the surface shape of the projections in the buttress region, and the outer appearance is formed in such a manner that the periphery of the surface of the projection is decorated by the group of spews. As a result, it is possible to reduce the deterioration of the design property of the tire side surface due to the spews.

In the vent hole 60 provided in the rectangular area, at least a part of the vent hole 60 may be provided within the rectangular area, however, the center of the vent hole 60 is preferably provided within the rectangular area. Further, the distance between the center of the vent hole 60 provided in the rectangular area and the side closest to the vent hole 60 is preferably 1.3 mm or more. In each of a plurality of vent holes 60 provided in the rectangular area, the decoration effect can be further enhanced in the case that the distance is set to be uniform (for example, fixedly 1.5 mm).

FIG. 13 shows an example in which the groove-shaped saw cut 70 is provided on the bottom surface 50s of the concave portion 50. The saw cut 70 forms a flow path for air at the cure molding time, and contributes to the reduction of the residual air within the concave portion 50 together with the vent hole 60. The saw cut 70 is away from a plurality of sides (the sides 50A to 50Q) which form the periphery of the bottom surface 50s of the concave portion 50, and a distance G3 thereof is preferably 1.3 mm or more. The saw cut 70 extends along each of a plurality of sides which form the periphery of the bottom surface 50s of the concave portion 50, and connects the vent holes 60 each other.

The shape of the concave portion for forming the projection provided in the buttress region contact portion 47 of the metal mold 40 corresponds to the shape of the projection provided in the buttress region of the tire, and a detailed structure or a preferable structure relating to the concave portion, and a modified example thereof are the same as the contents described with regard to the projection. Therefore, the other redundant description will be omitted. In the same manner, with regard to the vent hole and the saw cut, a redundant description thereof will be omitted since the contents described with regard to the spew and the ridge can be referred.

The tire cure metal mold according to the present invention can be structured in the same manner as the general tire cure metal mold except the provision of the vent hole as mentioned above on the bottom surface of the concave portion in the buttress region contact portion of the tire forming surface. Therefore, the conventionally known materials, shapes, structures, and manufacturing methods relating to the tire cure metal mold can be all employed in the present invention.

The present invention is not limited to the embodiment mentioned above, but can be improved and modified variously within the scope of the present invention.

What is claimed is:

1. A pneumatic tire comprising:
a pair of bead portions;
a pair of side wall portions which extend from the bead portions to an outer side in a tire diametrical direction;
a tread portion which is connected to an outer side end of each of the pair of side wall portions in the tire diametrical direction;
a plurality of projections which are provided in a buttress region of the side wall portions along a tire circumferential direction; and
a plurality of spews which protrude out of surfaces of the projections,
wherein in each of a plurality of sides forming a periphery of the surfaces of the projections, in the case that rectangular areas having a distance from the side being in a range of 2.5 mm or less are defined on the surfaces of the projections, at least one spew is provided in each of the rectangular areas.

2. The pneumatic tire according to claim 1, wherein a distance between a center of the spew provided in the rectangular area and the side closest to the spew is 1.3 mm or more.

3. The pneumatic tire according to claim 1, wherein a protruding amount of the spew positioned closest to an outer side in the tire diametrical direction on the surfaces of the projections is greater than a protruding amount of the spew positioned closest to an inner side in the tire diametrical direction.

4. The pneumatic tire according to claim 1, wherein a diameter of the spew positioned closest to an outer side in the radial direction on the surfaces of the projections is greater than a diameter of the spew positioned closest to an inner side in the tire diametrical direction.

5. The pneumatic tire according to claim 1, wherein linear ridges are provided on the surfaces of the projections.

6. The pneumatic tire according to claim 5, wherein the ridge extending along the side connects the spews each other.

7. A tire cure metal mold comprising:
a tire forming surface which comes into contact with an outer surface of a tire set in a cavity;
a plurality of concave portions which are provided in a buttress region contact portion of the tire forming surface along a tire circumferential direction; and
a plurality of vent holes which are provided on bottom surfaces of the concave portions,
wherein in each of a plurality of sides forming a periphery of the bottom surfaces of the concave portions, in the case that rectangular areas having a distance from the side being in a range of 2.5 mm or less are defined on the bottom surfaces of the concave portions, at least one vent hole is provided in each of the rectangular areas.

8. The tire cure metal mold according to claim 7, wherein a distance between a center of the vent hole provided in the rectangular area and the side closest to the vent hole is 1.3 mm or more.

9. The tire cure metal mold according to claim 7, wherein groove-shaped saw cuts are provided on the bottom surfaces of the concave portions.

10. The tire cure metal mold according to claim 9, wherein the saw cut extending along the side connects the vent holes each other.
